(19) United States
(12) Patent Application Publication
(10) Pub. No.: US 2022/0034418 A1
(43) Pub. Date: Feb. 3, 2022

(54) THERMOSTATIC MIXING VALVE

(71) Applicant: BÖME S.R.L., Cavallirio (IT)

(72) Inventor: Carlo MEDINA, Cavallirio (IT)

(21) Appl. No.: 17/386,595

(22) Filed: Jul. 28, 2021

(30) Foreign Application Priority Data
Jul. 29, 2020 (IT) 102020000018355

(51) Int. Cl. F16K 31/00; F16K 11/07

(52) U.S. Cl. CPC F16K 31/002; F16K 11/0704

(57) ABSTRACT

Thermostatic mixing valve including a valve body provided with an inner cavity, a first inlet for a first flow of water into the cavity, a second inlet for a second flow) of water into the cavity, and an outlet for a third flow of mixed water exiting the cavity, a mixing device shaped to be placed in fluid connection with the first inlet, the second inlet and the outlet, and to define a mixing chamber for the first and second flow, the mixing device being internally provided with a thermostatic actuating element that is movable along an operating direction, and a temperature adjusting device provided with a housing and with a positioning element that is slidable with respect to the housing, and configured for adopting, by adjustment, a set position with respect to the housing, and for imposing on the thermostatic actuating element a calibration position along the operating direction corresponding to a desired mixing temperature.

The mixing device includes a plug member connected to the thermostatic actuating element and drivable along the operating direction through the effect of a contracting/dilating movement of the thermostatic actuating element for controlling the entry of first flow and second flow into the mixing chamber so as to maintain the third flow at the desired mixing temperature. The mixing device is removably housed in the cavity by coupling at least one abutting portion of the mixing device with at least one abutting surface of the cavity. On the valve body, in a position opposite to the outlet, an opening end is provided to enable the mixing device to be inserted into the cavity; the temperature adjusting device, in a coupling configuration is shaped for coupling with the mixing device along a coupling surface and for closing the opening end; the positioning element is configured for remaining in the set position with respect to the housing also in a decoupling configuration of the temperature adjusting device from the mixing device and from the valve body, so as to preserve, once the temperature adjusting device, the mixing device and the valve body have been subsequently recoupled, the calibration position corresponding to the desired mixing temperature.

The invention relates to a thermostatic mixing valve.

In particular, the invention relates to a thermostatic mixing valve arranged to adjust a temperature of a fluid flow, in particular water, circulating in a supply system to one or more users.

### BACKGROUND OF THE INVENTION

There are known thermostatic mixing valves used in hot water supply systems for sanitary use, having the function to maintain constant, at a set value, the temperature of the mixed water sent to the user, as conditions regarding temperature, pressure, cold and hot water flow rate entering the valve, change. The thermostatic mixing valve includes a valve body provided with a first inlet for hot water, a second inlet for cold water and an outlet for the mixed water. The valve includes a hollow cartridge element, mounted inside the valve body and provided with walls in fluid communication with the inlets and the outlet, and defining, in the valve body, a mixing chamber in which the hot fluid is mixed with the cold fluid. The valve also includes a thermosensitive element, intended to contact, in use, the fluid mixed in the mixing chamber and capable of expanding or contracting depending on the temperature of the mixed fluid. The valve further includes a temperature adjusting element, that is connected by screwing to the valve body by means of a first clamping ring nut on a first opening obtained on the valve body. The adjusting element is provided with a piston operatively connected to the thermosensitive element in an assembly configuration. Both elements are movable inside the mixing chamber. A position of the piston is set along an operative axis of the valve body, according to a screwing direction and pitch of the first ring nut on the valve body. Correspondingly to such a position, a further position is adopted by the thermosensitive element, and the latter position corresponds to a desired exit temperature of the fluid mixed by the valve. In fact, the cartridge element includes a sliding part connected to the aforesaid element; the sliding part adopts a position along the operative axis according to the position adopted by the thermosensitive element and may move as a consequence of a dilation/contraction movement of the thermosensitive element along the main axis of the valve body. The sliding part cooperates with a fixed part of the cartridge element to define a passage area for the entry of hot fluid and a passage area for the entry of cold fluid. In particular, a sliding part movement causes a variation of the aforesaid passage areas, so as to balance the hot and cold flow rates flowing together into the mixing chamber to keep constant the maximum exit temperature of the valve fluid. The valve body includes an antagonist spring acting on the sliding part of the cartridge element and pushing it from the bottom upwards. The temperature adjusting element includes an additional antagonist spring acting on the piston. In the assembly configuration the force exerted by the additional spring connected to the piston is transferred also to the sensitive element, and consequently to the sliding part of the cartridge element, thus pushing such sliding part from top downwards and balancing the force applied on such sliding part by the antagonist spring.

The cartridge element is inserted into the valve body by screwing a second clamping ring nut on a second opening provided on the valve body; the second ring nut is connected to the fixed part of the cartridge element and supports it in its position.

The above-described mixing valve has some drawbacks.

First of all, due to the rather complex structure of the components forming the valve, it is not possible to have direct access to all the inner components of the valve. Inspection and/or maintenance and/or component replacement and/or valve cleaning operations are time-consuming, expensive and may be hard, if not impossible, to be implemented when the space available for manoeuvres is limited and poorly accessible to make it possible to extract all the inner components of the valve.

More specifically, before performing a maintenance operation, the operator firstly has to unscrew both the first support ring nut to remove the temperature adjusting element and the second support ring nut to remove the cartridge element.

Another drawback is that, after performing the maintenance operation, the operator has to carry out again a calibration/setting of the temperature of the fluid exiting the valve. In fact, he has to assemble again the cartridge element in the valve body, by screwing the second clamping ring nut, and then assemble again the temperature adjusting element on the valve body, by screwing the first ring nut on the first opening. In particular the operator has to adjust again the position of the temperature adjusting element and of the piston so that the latter can abut again the thermosensitive element, and restore the operating parameters as before the maintenance intervention.

This involves an additional waste of time to calibrate again the temperature of the flow exiting the mixing valve.

### SUMMARY OF THE INVENTION

An object of the present invention is to improve the known thermostatic mixing valves. Another object of the invention is to supply a thermostatic mixing valve which makes it possible to carry out a temperature calibration of a fluid exiting therefrom in a simple and rapid way and enabling an operator to carry out inspection and/or maintenance and/or replacement operations of the valve inner parts without having to calibrate anew the temperature of the fluid exiting the valve.

A further object of the invention is to provide a mixing valve whose parts are of simple and cheap construction.

Another further object is to provide a thermostatic mixing valve which makes it possible to carry out inspection/maintenance operations thereon in a simple and rapid way, in particular enabling a direct access to the inner parts at a single access point of the mixing valve and enabling to easily and rapidly assemble and/or disassemble such inner parts.

Such objects and still more are reached by a thermostatic mixing valve, as described in one or more of the claims reported below.

Owing to the invention, it is provided a mixing valve including a valve body defining an inner cavity and on which an opening end is obtained that is sized to enable a mixing device to be inserted into the inner cavity of the valve body, such mixing device being arranged to mix a flow of hot fluid with a flow of cold fluid.

Owing to the invention it is provided to removably house the mixing device in the cavity, so as to make it easy to remove it.

Owing to a temperature adjusting device for the fluid exiting the valve, that is shaped to be coupled with the mixing device and to close the opening end, the mixing device is locked in the proper position inside the aforesaid cavity.

Owing to a positioning element provided in the temperature adjusting device, that slide with respect to a housing of the temperature adjusting device and configured to adopt, by adjustment, a set position relative to the housing, it is possible to impose to a thermostatic actuating element, included in the mixing device, a calibration position along an operating direction corresponding to a desired mixing temperature.

Owing to the shape of the temperature adjusting device, the positioning element is configured to remain in the set position even in the decoupling configuration so as to maintain, once the temperature adjusting device and the mixing device and the valve body are recoupled, the calibration position corresponding to the desired mixing temperature.

### BRIEF DESCRIPTION OF THE DRAWINGS

The invention will be better understood and implemented with reference to the accompanying drawings which show an exemplary and non-limiting implementation, wherein:

FIG. 1 is an exploded front view of a thermostatic mixing valve according to the invention;

FIG. 2 is a section front view of the valve of FIG. 1 wherein the valve components of the valve are in a coupling configuration;

FIG. 2A is an enlarged detail of FIG. 2;

FIG. 3 is a section front view of the valve of FIG. 1 wherein the valve components are coupled with each other and adopt a first calibration configuration wherein a fluid exits the valve with a first mixing temperature;

FIG. 3A is a section front view of the valve of FIG. 1 wherein the valve components are mutually decoupled and adopt the first calibration configuration;

FIG. 4 is a section view of the valve of FIG. 1 wherein the valve components are coupled with each other and adopt a second calibration configuration wherein a fluid exits the valve with a second mixing temperature;

FIG. 4A is a section view of the valve of FIG. 1 wherein the valve components are decoupled and adopt the second calibration configuration;

FIG. 4B is a section side view of the valve of FIG. 1 wherein the valve components are decoupled and are in the second calibration configuration.

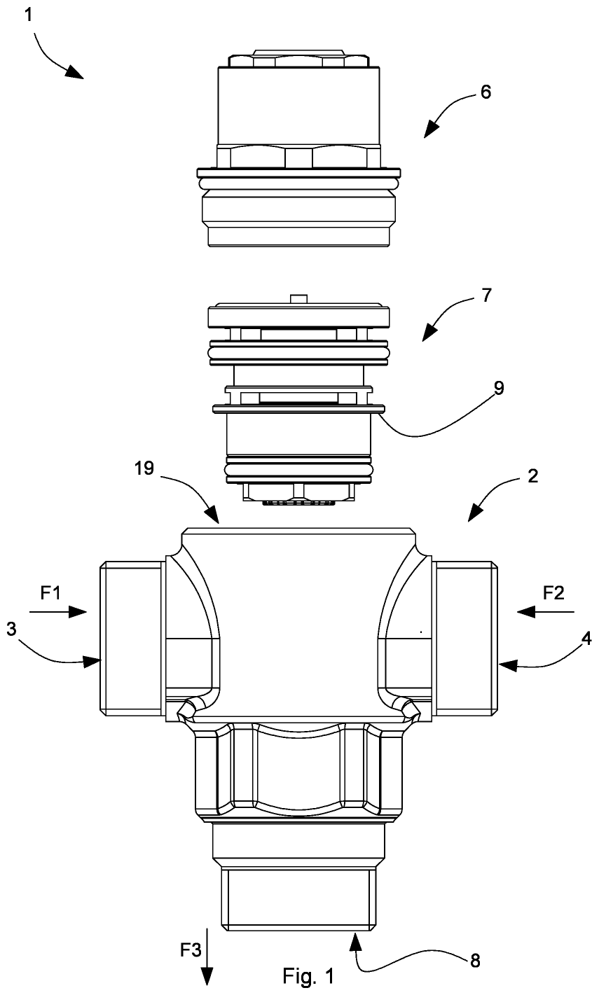

### DETAILED DESCRIPTION

With reference to the enclosed Figures, it is shown a thermostatic mixing valve 1 adapted to be assembled in a building heating circuit, in particular in sanitary systems, and having the function to maintain the temperature of the exiting mixed water, constant, at a desired value. The thermostatic mixing valve 1 may be assembled upstream of a system for supplying a fluid to one or more users.

As will be clear in greater detail from the following description, the thermostatic mixing valve 1 is configured to keep the temperature of the mixed water at a desired value based on a calibration or setting operation carried out on the components of the valve. Furthermore, the thermostatic mixing valve 1, or thermostatic mixing valve unit, allows to self-regulate the temperature as the water supply conditions, i.e., the temperatures of the entering water flows, vary.

The thermostatic mixing valve 1 includes a valve body 2 provided with an inner cavity 18.

The valve body 2 includes a first inlet 3 for a first flow of water F1 into the cavity 18, in particular a flow of hot water, a second inlet 4 for a second flow of water F2 into the cavity 18, in particular cold water, and an outlet 8 for a third flow of mixed water F3 exiting from the cavity 18 and the valve body 2.

The first inlet 3 and the second inlet 4 are provided on two opposite sides of the valve body 2. The first inlet 3 and the second inlet 4 are delimited by respective connection portions obtained on the walls of the valve body 2 such that the first flow F1 and the second flow F2 enter the cavity 18 according to two flow directions that are substantially parallel and opposite to each other. The outlet 8 is delimited by a respective connection portion on another valve body wall, distinct from the two previously described walls, and it is positioned with respect to the first 3 and the second inlet 4 such that the third flow F3 exits the cavity 18 in a transversal exit direction, in particular orthogonal, with respect to the inlet direction of the first F1 and/or second F2 flow.

An opening end 19 is obtained on the valve body 2 in a position opposite to the exit 8.

The valve 1 includes a mixing device 7 removably housed in the cavity 18. The opening end 19 is sized to allow a mixing device 7 to be inserted into the cavity 18.

The mixing device 7 is removably housed in the cavity 18 by coupling at least one abutting portion 9a, which the mixing device 7 is provided with at least one abutting surface 9b provided in the cavity 18.

The abutting portion 9a rests on the at least one abutting surface 9b. The abutting surface 9a has an annular protruding shape and the abutting surface 9b is a shoulder surface obtained in the cavity 18.

The mixing device 7 is further shaped to be placed in fluid communication with the first inlet 3, with the second inlet 4 and with the outlet 8. The mixing device is also shaped to define a mixing chamber 5 in the cavity 18 for the first flow F1 and the second flow F2, inside which the first flow F1 and the second flow F2 can be mixed to obtain the third flow F3 of mixed water.

The mixing device 7 is internally provided with a thermostatic actuating element 10 movable along an operating direction D. The thermostatic actuating element 10 is immersed in the mixing chamber 5, i.e., it is in contact with the first F1 and/or second F2, and/or third flow F3 and is able to shrink or dilate based on the temperature of such first F1 and/or second F2 and/or third flow F3. The thermostatic actuating element 10 includes in particular a wax thermosensitive sensor. In the version shown in the enclosed Figures, the operating direction D is transversal, in particular orthogonal, to the inlet direction of the first flow F1.

The valve 1 further includes a temperature adjusting device 6, provided with a housing 12 and a positioning element 11 sliding with respect to the housing 12.

The positioning element 11 is configured to adopt, by a hereinafter disclosed adjustment, a set position with respect to the housing 12. The positioning element 11 includes a plate-shaped element or a piston.

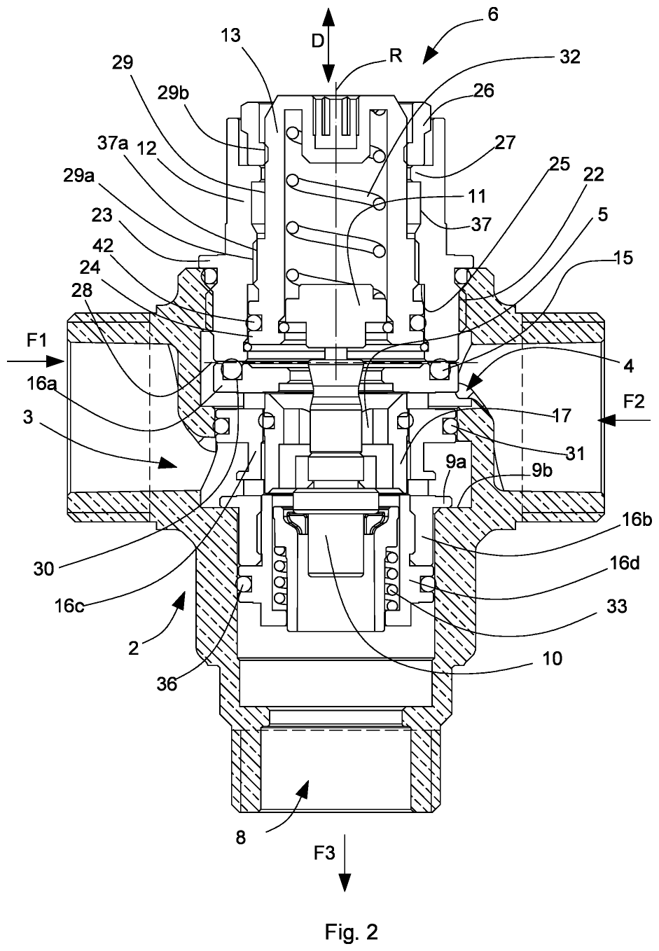

The housing 12, shown for instance in FIGS. 2 and 2A, has a hollow cylindrical shape. The hollow cylinder is open at both ends.

The housing 12 is shaped to be coupled by screwing, i.e., by a threaded coupling, to an inner wall 22 of the opening end 19.

The housing 12 further includes an annular flange 23 shaped to abut on a surface of the valve body 2 adjacent to the opening end 19 so as to define an end-of-stroke for screwing the housing 12 on the opening end 19.

The temperature adjusting device 6 further includes a cap-shaped cylindrical body 13 inside which the positioning element 11 is slidably housed.

The cylindrical body 13 includes a wall 29 at least partially housed in the housing 12. The wall 29 includes a wall portion 29a shaped to be coupled by screwing with a respective wall portion 37a of a wall 37 of the housing 12. While screwing, a rotation of the cylindrical body 13 about a longitudinal axis R thereof enables the positioning element 11 to move along the operating direction D and adopt the aforesaid set position with respect to the housing 12.

As may be inferred from what described and from the enclosed figures, the housing 12 is provided with threads obtained on two cylindrical surfaces delimiting the cylindrical wall of the housing 12 and opposite to each other. In particular a first thread is obtained on an outer cylindrical surface to enable screwing the housing 12 on the wall 22 of the opening end 19, and a second thread is obtained on an inner cylindrical surface to enable the cylindrical body 13 to be screwed inside the housing 12. The screwing of the cylindrical body 13 in the housing 12 is totally independent and irrespective of the screwing of the housing 12 in the opening end 19.

In the version shown in the enclosed figures, the longitudinal axis R is parallel to the operating direction D.

The cylindrical body 13 is provided with an annular ridge 24 near the wall portion 29a, and is shaped to abut on a first abutting shoulder 25 obtained near the wall portion 37a of the housing 12 so as to limit the rotation of said cylindrical body 13.

The annular ridge 24 may be provided at a wall end 29 placed inside the housing 12. The annular ridge 24 is shaped to sealingly couple with the wall 37 by interposition of a sealing gasket 42.

The temperature adjusting device 6 includes a safety ring nut 26 coupled by screwing with the cylindrical body 13, in particular coupled by screwing with another wall portion 29b of the wall 29 protruding out of the housing 12. The safety ring nut 26 is configured to be screwed on the other wall portion 29b after the cylindrical body 13 has been screwed/rotated into the housing 12, until abutting a second abutting shoulder 27 obtained on an end portion of the housing 12 so as to lock in place the cylindrical body 13 with respect to the housing 12 and prevent possible undesired movements, or unscrewing of the cylindrical body 13.

Still, on an end portion of the wall 37, an annular groove 40 is obtained and sized to house a locking element 41. The annular seat is radially hollow with respect to the wall 37. The locking element 41 is a ring that is shaped so as to radially protrude from the annular groove 40 inside the housing 12 and to abut against the annular ridge 24 so as to limit the movement thereof along the operating direction D and prevent the cylindrical body 13 from exiting the housing 12 while screwing such cylindrical body 13 inside the housing 12. The locking element 41 is made of metal material.

With reference to FIG. 2A, inside the cylindrical body 13, in particular on an internal wall 39 of the cylindrical body 13, an annular housing is obtained 34 to receive an abutment ring 35. The abutment ring 35 is made of an elastic rigid, or semi-rigid material, for example a metal alloy. The abutment ring 35 is partially protruding in a radial direction inside the cylindrical body 13 and is sized to abut the positioning element 11 so as to limit the movement thereof 11 along the operating direction D and prevent such positioning element 11 from exiting the cylindrical body 13.

Inside the cylindrical body 13 it is provided a spring element 32 that is operationally connected to the positioning element 11 and that is sized to apply an elastic force to the positioning element 11 so as to maintain the positioning element abutting on said abutment ring 35. Th spring element 32 includes a compression spring fixed with a first end to an upper base wall of the cylindrical body 13, and with another end to the plate-shaped element.

In FIGS. 2, 2A, 3 and 4 a coupling configuration CA is shown, wherein the temperature adjusting device 6 is coupled with the mixing device 7 and with the valve body 2.

In the coupling configuration CA the temperature adjusting device 6 is shaped to couple with the mixing device 7 along a coupling surface 28. In the version shown in the enclosed Figures, the coupling surface 28 is a plane surface, i.e. the mixing device 7 and the temperature adjusting device 6, include two plane surfaces which mutually couple defining a planar interface zone.

In a version which is not shown, the mixing device 7 and the temperature adjusting device 6 may include concave/convex surfaces or having another desired geometrical shape and are shaped to mutually couple so as to define a non-planar interface zone, for instance with an irregular trend; the coupling surface can thus be a complex, non-plane, wavy surface.

In the coupling configuration CA, the temperature adjusting device 6 is shaped so as to close the opening end 19 of the valve body.

In the coupling configuration CA of the temperature adjusting device with the mixing device 7, the positioning element 11, having adopted the set position with respect to the housing 12 as described above, is in contact with the thermostatic actuating element 10. In particular the positioning element 11 is in contact with an end portion 14 of the thermostatic element 10. The positioning element 11 is thus configured to impose to the thermostatic actuating element 10 a calibration position along the operating direction D; such calibration position corresponds to a desired mixing temperature of the first F1 and second F2 flow, and therefore corresponds almost to the temperature of the third flow F3 exiting from the valve body, as explained hereinafter.

The mixing device 7 includes a plug member 17 and a closing arrangement which delimit a space in the cavity 18 wherein the two flows F1 and F2 can mix, i.e., the plug member 17 and the closing arrangement define the aforesaid mixing chamber 5.

The plug member 17 includes a hollow tubular body which is open at both ends.

The closing arrangement includes a body provided with a first annular portion 16a shaped to couple along the coupling surface 28 with the temperature adjusting device 6, in particular with an end portion of the housing 12.

On a face of the first annular portion 16a, at the coupling surface 28, an annular seat 30 is obtained which houses watertight a sealing element 15, such as an “O-ring”, to avoid fluid leakage between the mixing device 7 and the temperature adjusting device 6 in the coupling configuration CA.

The body is provided with a second annular portion 16b provided with said abutting portion 9a housed on the abutment shoulder 9b.

The body is further provided with a third annular portion 16c interposed between the first 16a and the second annular portion 16b shaped to sealingly cooperate with a cavity wall 18 by interposing a sealing element 31. The third annular portion 16c is shaped to surround the plug member 17.

Still, the body is provided with a fourth annular portion 16d provided in a position opposite to that occupied by the first annular portion 16a along the operating direction D. The fourth annular portion 16d is shaped to sealingly cooperate with another wall of said cavity 18 by interposing an additional sealing element 36.

The plug member 17 is connected to the thermostatic actuating element 10; the plug member 17 thereby adopts a position in the cavity 18 and with respect to the closing arrangement based on the calibration position adopted by the thermostatic actuating element 10.

The plug member 17 is furthermore drivable along the operating direction D through the effect of a contracting/dilating movement of the thermostatic actuating element 10.

The plug member 17 is shaped to cooperate with the closing arrangement, in particular with the third annular position 16c, along the operating direction D to define a first variable area passage 20 and a second variable area passage 21 for the access into the mixing chamber of the first flow F1 and the second flow F2 respectively. The plug member 17 is shaped to sealingly couple with the closing arrangement, in particular with the third annular portion 45 so as to avoid leakages of fluid out of the mixing chamber 5.

Thanks to the movement of the thermostatic actuating element 10 and of the plug member 17, it is possible to control the first flow F1 and the second flow F2 entering into the mixing chamber 5 so as to maintain the third flow F3 at a desired mixing temperature, as explained hereinafter in detail.

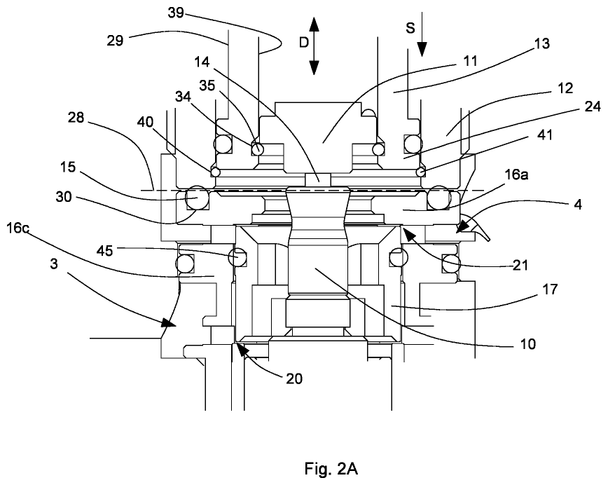

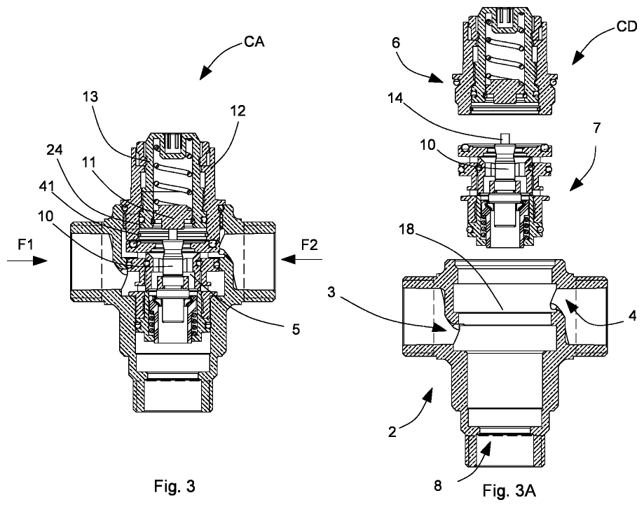

In FIGS. 3, 3A, the various components of the valve are shown in a coupled CA configuration and in an uncoupled configuration CD, wherein the positioning element 11 adopt a first position with respect to the housing 12. As it can be seen in FIG. 3, the cylindrical body 13 was screwed into the housing for a given number of revolutions about the longitudinal axis R so that the annular ridge 24 of the cylindrical body 13 is spaced apart from the locking element 41 of the housing 12, for a given amount that is measured parallelly to the operating direction D. Depending on the rotation of the cylindrical body 13, the positioning element 11 was moved along the operating direction D and adopted a first position with respect to the housing 12. In such first position, the positioning element 11 imposes to the end portion 14, and thereby to the thermostatic actuating element 10, a first calibration position. Such calibration position corresponds to a position adopted by the plug member 17 with respect to the closing arrangement 16c, and to a consequent first passage area of the first flow F1 of hot water and second flow F2 of cold water into the mixing chamber 5 and to a corresponding first mixing temperature at which the third flow F3 exits from the mixing chamber and the valve body 2.

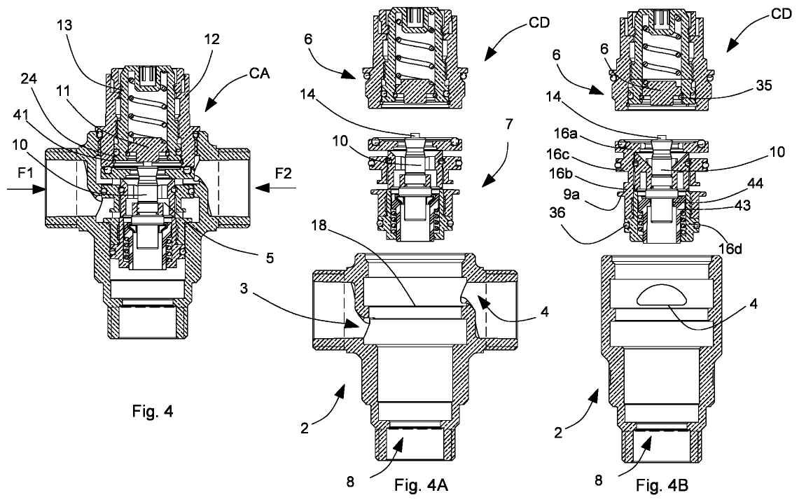

Similarly, in FIGS. 4 and 4A and 4B, the various components of the valve are shown in a coupled CA and uncoupled CD configuration, wherein the positioning element 11 adopts a second position with respect to the housing 12. As it can be seen, the cylindrical body 13 was screwed into the housing for a given number of revolutions about the longitudinal axis R so that the annular ridge 24 of the cylindrical body 13 was in contact with the locking element 41 of the housing 12, such a distance being measured parallelly to the operating direction D. The positioning element 11 was moved along the operating direction D and adopted a second position with respect to the housing 12. In such second position, the positioning element 11 imposes to the end portion 14, and consequently, to the thermostatic actuating element 10, a second calibration position. Such second calibration position corresponds to a position adopted by the plug member 17 with respect to the closing arrangement 16c, and to a consequent second passage area of the first flow F1 of hot water and second flow F2 of cold water into the mixing chamber 5 and to a corresponding second mixing temperature at which the third flow F3 exits from the mixing chamber and the valve body 2.

In both the calibration configurations just shown, a variation in the temperature of the hot and/or cold water flow entering the mixing chamber causes a dilation and/or contraction of the thermostatic actuating element 10, and an additional consequent movement of the plug member along the operating direction D with respect to the closing arrangement 16c so as to vary the passage areas 20 and 21. This allows to balance/control the flows entering the mixing chamber 5 and maintain the third flow F3 at the desired mixing temperature.

The mixing device 7 is further provided with a guide tubular element 43, shown in FIG. 4B, arranged to guide the third flow F3 of mixed water from the mixing chamber 5 towards the outlet 8 of the valve body when the mixing device 7 removably rests in the cavity 18. The guide tubular element 43 is surrounded by the fourth annular portion 16d. The guide tubular element 43 is connected to the thermostatic actuating element 10 by at least a protrusion 44 radially protruding from an inner surface of a wall of the guide tubular element 43 facing the thermostatic actuating element 10. Therefore, the guide tubular element 43 is also slidable along the operating direction D and is susceptible to movements deriving from the position imposed to the thermostatic actuating element 10 by the positioning element 11, and by a contraction/dilation of the thermostatic actuating element 10 while the flows circulate in the mixing chamber 10.

The guide tubular element 43 is in fluid communication with the mixing chamber 5.

The protrusion 44 projects by such an extent that it contacts a shoulder obtained on the thermostatic actuating element 10. In particular the guide tubular element 43 is provided with a plurality of radially protruding protrusions 44 angularly spaced apart from each other along an inner surface portion of the wall of the guide tubular element 43.

In another portion of the guide tubular element 43, that is lower than the portion wherein the plurality of protrusions 44 is provided, the guide tubular element 43 is connected to an additional spring element 33 sized to apply an elastic force on the guide tubular element 43 such to keep the plurality of protrusions 44 in contact with the shoulder of the thermostatic actuating element 10. The additional spring element 33 includes a compression spring.

Observing FIG. 4B, the elastic force exerted by the additional spring element 33 acts in a direction substantially parallel to the operating direction D, from bottom upwards. When the guide tubular element 43 is actuated downwards, such as through the effect of a dilation of the thermostatic actuating element 10, the additional spring element 33 is compressed, opposes to such movement and ensures that the guide tubular element 43 remains in contact with the thermostatic actuating element 10. Similarly, when the thermostatic actuating element 10 contracts, the additional spring element 33 tends to return to the non-deformed configuration, by applying an elastic force on the guide tubular element 43 such to make it possible to remain in contact with the thermostatic actuating element 10.

In the enclosed Figures, in particular in FIGS. 2, 3 and 4, a coupling configuration CA is shown wherein the mixing device 7 rests in the inner cavity 18 of the valve body 2, and the temperature adjusting device 6 is coupled with the mixing device 7 along the coupling surface 28, and closes the opening end 19.

In the coupling configuration CA, the temperature adjusting device 6 exerts a clamping force S on the mixing device 7 to lock in position the at least an abutting portion 9a on the at least an abutting surface 9b. Observing the figures, the temperature adjusting device 6 is operatively positioned above the mixing device 7 and the clamping force S is directed from the top downwards. The clamping force S is substantially parallel to the operating direction D.

In the version shown the temperature adjusting device 6 is coupled with the mixing device 7 without screwing.

In a version which is not shown, the temperature adjusting device 6 may be coupled with the mixing device 7 through screwing.

In FIGS. 3A, 4A and 4B a decoupling configuration CD is shown wherein the adjusting device is decoupled from the valve body, in particular from the opening end 19 and from the mixing device 7, in turn decoupled from the valve body 2.

To switch from the coupling configuration CA to the decoupling configuration, an operator must decouple the temperature adjusting device 6 from the valve body 2, by unscrewing the housing 12 from the opening end 19. Thanks to the shape of the temperature adjusting device 6, it is sufficient to unscrew the housing 12 to decouple it from the valve body 2.

Once the temperature adjusting device 6 has been decoupled, or removed, the mixing device 7 is no longer locked, but it simply rests in the cavity 18 of the valve body 2. Thanks to the simple shape of the abutment portion 9a and of the at least an abutment surface 9b, the operator is able to easily remove the mixing device 7 from the valve body 2 to reach the decoupling configuration CD.

The extraction of the mixing device 7 occurs in a direction substantially parallel to the operating direction D.

It is thus possible to carry out maintenance, repair and replacement operations of the mixing device 7, or of other inner components of the valve body.

To switch from the decoupling configuration to the coupling configuration, the same operation will have to be repeated, though inverting the sequence.

Thanks to the threaded coupling 29a, 37 between the cylindrical body 13 and the housing 12, the cylindrical body 13 remains in its screwed position with respect to the housing 12 even in the decoupling configuration, as previously explained in detail.

Similarly, based on the foregoing, the positioning element 11 is configured to stay in the set position with respect to the housing 12, or inside the cylindrical body 13, even in the decoupling configuration CD, so as to maintain the calibration position corresponding to the desired mixing temperature once the temperature adjusting device 6 has been coupled again with the aforesaid mixing device 7 and with the valve body 2.

Thanks to the disclosed invention, it is therefore possible to carry out maintenance and/or repair and/or replacement operations of the components of the mixing valve without having to set the temperature of the flow exiting the valve after each of the aforesaid operations.

Thanks to the disclosed invention it is possible to couple and decouple, simply and rapidly, the components of the valve, providing for a single place, or area, on the valve body, through which the mixing device and the temperature adjusting device are to be inserted or extracted.

To conclude, the following features can be inferred from the above disclosed:
the temperature adjusting device 6 may be removed “in a single piece” as the inner components remain mutually positioned and coupled in the set calibration configuration;
the mixing device 7 may also be removed “in a single piece” as its inner components remain mutually coupled in the position adopted during an operating step of the valve;
a mixing valve having a simple and cheap structure is obtained, wherein only the actually worn or damaged components may be replaced.

1. Thermostatic mixing valve including:
a valve body provided with an inner cavity, a first inlet for a first flow of water into said cavity, a second inlet for a second flow of water into said cavity, and an outlet for an exit of a third flow of mixed water from said cavity;
a mixing device shaped to be placed in fluid connection with said first inlet, said second inlet and said outlet, and to define a mixing chamber for said first and second flow in said cavity, said mixing device being internally provided with a thermostatic actuating element that is movable along an operating direction; and
a temperature adjusting device provided with a housing and with a positioning element that is slidable with respect to said housing, said positioning element being configured for adopting, by adjusting, a set position with respect to said housing, in a coupling configuration of said temperature adjusting device with said mixing device, said positioning element being also configured for imposing on said thermostatic actuating element a calibration position along said operating direction corresponding to a desired mixing temperature;
said mixing device including a plug member connected to said thermostatic actuating element and drivable along said operating direction through the effect of a contracting/dilating movement of said thermostatic actuating element for controlling the entry of said first flow and said second flow in said mixing chamber so as to maintain said third flow at said desired mixing temperature, wherein said mixing device is removably housed in said cavity by coupling at least one abutting portion of said mixing device with at least one abutting surface of said cavity, in that on said valve body, in a position opposite to said outlet, an opening end is obtained to enable said mixing device to be inserted into said cavity, in that said temperature adjusting device, in said coupling configuration, is shaped for coupling with said mixing device along a coupling surface and for closing said opening end, and in that said positioning element is configured for remaining in said set position with respect to said housing also in a decoupling configuration in which said temperature adjusting device is decoupled from said mixing device and from said body valve, so as to preserve, once said temperature adjusting device, said mixing device and said valve body have been recoupled, said calibration position corresponding to said desired mixing temperature.

2. Valve according to claim 1, wherein in said coupling configuration said abutting portion of said mixing device rests on said at least one abutting surface, said at least one abutting portion and said at least one abutting surface being shaped for enabling said mixing device to be easily extracted from said valve body to reach said decoupling configuration.

3. Valve according to claim 1, wherein said abutting portion has an annular protrusion shape and said abutting surface is a shoulder surface obtained in said cavity.

4. Valve according to claim 1, wherein said mixing device further includes a closing arrangement, said plug member cooperating with said closing arrangement along said operating direction to define a first variable area passage for the entry of said first flow in said mixing chamber through said first inlet and a second variable area passage for the entry of said second flow in said mixing chamber through said second inlet.

5. Valve according to claim 4, wherein said plug member includes a tubular body and said closing arrangement includes a body provided with at least one first annular portion shaped for coupling along said coupling surface with said temperature adjusting device and at least one second annular portion provided with said abutting portion.

6. Valve according to claim 5, wherein said body of said closing arrangement is further provided with at last one third annular portion, interposed between said first and second portion, and shaped for sealingly cooperating with a wall of said cavity by interposition of a sealing element, and a fourth annular portion provided in a position opposite to that occupied by said first annular portion along said operating direction and shaped for cooperating sealingly with another wall of said cavity by interposition of a further sealing element.

7. Valve according to claim 1, wherein said temperature adjusting device, in said coupling configuration, exerts a clamping force on said mixing device to lock in position said at least one abutting portion on said at least one abutting surface along said operating direction.

8. Valve according to claim 1, wherein said temperature adjusting device is coupled in a screwless way along said coupling surface with said mixing device.

9. Valve according to claim 1, wherein at said coupling surface on said mixing device an annular seat housing a hermetic watertight sealing element is obtained to prevent, in said coupling configuration, leaks of fluid between said mixing device and said temperature adjusting device.

10. Valve according to claim 1, wherein said housing of said temperature adjusting device has a shape of a hollow cylinder adapted for being coupled through screwing with an inner wall of said opening end, said housing further including an annular flange shaped for abutting on a surface of said valve body adjacent to said opening end so as to define an end-of-stroke for screwing said housing on said opening end.

11. Valve according to claim 1, wherein said temperature adjusting device includes a cap-shaped cylindrical body inside which said positioning element is slidably housed, a wall of said cylindrical body being at least partially housed in said housing and including a wall portion shaped for coupling by screwing with a respective wall portion of said housing, a rotation of said cylindrical body around a longitudinal axis thereof enabling said positioning element to move along said operating direction and adopting said set position with respect to said housing.

12. Valve according to claim 11, wherein said cylindrical body is provided with an annular ridge near said wall portion and shaped for abutting on a first abutting shoulder obtained near said wall portion of said housing so as to limit said rotation of said cylindrical body.

13. Valve according to claim 11, wherein said cylindrical body includes a safety ring nut coupled by screwing with another wall portion of said wall protruding outside said housing, said safety ring nut being shaped to abut on a second abutting shoulder obtained on an end portion of said housing to secure said cylindrical body with said housing.

14. Valve according to claim 11, wherein inside said cylindrical body an annular housing is obtained for an abutment ring, said abutment ring being partially radially protruding inside said cylindrical body to abut on said positioning element so as to limit a movement of said positioning element along said operating direction and prevent said positioning element from exiting said cylindrical body both in said coupling configuration and in said decoupling configuration.

15. Valve according to claim 14, wherein said positioning element is operationally connected to a spring element sized to apply to said positioning element an elastic force so as to maintain said positioning element abutting on said abutment ring both in said coupling configuration and in said decoupling configuration.
